(19) United States
(12) Patent Application Publication
(10) Pub. No.: US 2017/0211288 A1
(43) Pub. Date: Jul. 27, 2017

(54) RUBBER BEARING

(71) Applicant: DENKA COMPANY LIMITED, Tokyo (JP)

(72) Inventors: Yasushi KAMIHIGASHI, Nagoya-shi, Aichi (JP); Shinichirou KUMAGAI, Nagoya-shi, Aichi (JP); Takumi NISHIMURA, Nagoya-shi, Aichi (JP); Koji FUJITA, Nagoya-shi, Aichi (JP); Takehiro TOMITA, Kobe-shi, Hyogo (JP); Tatsuji MATSUMOTO, Kobe-shi, Hyogo (JP); Yasuhiko KONDO, Kobe-shi, Hyogo (JP); Yasuchika ITO, Kobe-shi, Hyogo (JP); Takashi SUNADA, Itoigawa-city, Niigata (JP); Nobuhiko FUJII, Tokyo (JP); Hideki TOYA, Itoigawa-city, Niigata (JP); Yasushi ABE, Itoigawa-city, Niigata (JP)

(73) Assignee: DENKA COMPANY LIMITED, Tokyo (JP)

(21) Appl. No.: 15/515,394

(22) PCT Filed: Sep. 29, 2015
(86) PCT No.: PCT/JP2015/077425

§ 371 Date: Mar. 29, 2017

(30) Foreign Application Priority Data
Oct. 1, 2014 (JP) 2014-203376

(51) Int. Cl. E04H 9/02; B32B 7/12; E01D 19/04; F16F 15/08; E04B 1/36; E04B 1/98; B32B 25/04; B32B 27/32

(52) U.S. Cl. CPC E04H 9/022; B32B 25/04; B32B 7/12; B32B 27/32; F16F 15/08; E04B 1/36; E04B 1/98; E01D 19/041; B32B 2419/00

(57) ABSTRACT

Provided is a rubber bearing formed from a polychloroprene composition and having higher ozone resistance.

The rubber bearing comprises a laminate prepared by alternately laminating a plurality of soft layers having rubber elasticity and a plurality of hard layers having rigidity, and a covering layer covering an outer peripheral part of the laminate. The soft layer comprises a rubber composition containing a polychloroprene, and the covering layer comprises a blend rubber composition containing 30 to 95 parts by mass of a polychloroprene and 70 to 5 parts by mass of an elastomer other than the polychloroprene.

### TECHNICAL FIELD

The present invention relates to a rubber bearing used for structures including bridges and buildings as a countermeasure against earthquake and specifically relates to a rubber bearing formed from a polychloroprene composition and having higher ozone resistance.

### BACKGROUND ART

One of the application of polychloroprene compositions is a rubber bearing. The rubber bearing is installed between the foundation of a structure including bridges and buildings and the upper structure thereof and reduces the vibrations of the building in the horizontal direction in case of earthquake. The rubber bearing has a structure in which a plurality of soft layers having rubber elasticity and a plurality of hard layers having rigidity are alternately laminated, and is required to have high rigidity and high strength in the vertical direction and to have lower rigidity and larger deformability in the horizontal direction than the vertical direction.

The polychloroprene composition for rubber bearings includes a polychloroprene composition that is prepared by mixing a xanthogen-modified polychloroprene with acetylene black and gives a vulcanized product having a relation between breaking elongation and static shear modulus within a particular range (for example, see Patent Document 1). A polychloroprene composition prepared by mixing a mixture of a xanthogen-modified polychloroprene and/or a mercaptan-modified polychloroprene and a sulfur-modified polychloroprene at a particular ratio with a particular amount of acetylene black is also disclosed (for example, see Patent Document 2).

As the rubber bearing, other materials except the polychloroprene composition are also used. For example, a rubber bearing having excellent damping characteristics and durability is produced by laminating layers of a high-damping rubber such as natural rubber and hard plate layers and forming the outer peripheral part from a low-damping rubber (for example, see Patent Document 3). Another rubber bearing exerting, in addition to the above characteristics, excellent damping performance independent of temperature is produced by mixing natural rubber with a carbon black having a particular nitrogen adsorption specific surface area and a particular DBP absorption amount (for example, see Patent Document 4).

### CITATION LIST

### Patent Literature

Patent Document 1: JP-A No. H11-315169

Patent Document 2: JP-A No. 2003-292681

Patent Document 3: JP-A No. 2012-7123

Patent Document 4: JP-A No. 2011-21046

### SUMMARY OF THE INVENTION

### Technical Problem

Rubber bearings are used for a long time during the use of a structure. Depending on a place at which a rubber bearing is installed, the rubber bearing may be degraded by ozone, and cracks generated on the surface may accelerate the deterioration of the durability.

The present invention is directed to provide a rubber bearing formed from a polychloroprene composition, specifically, a rubber bearing having higher ozone resistance.

### Solution to Problem

A rubber bearing pertaining to the present invention comprises a laminate prepared by alternately laminating a plurality of soft layers having rubber elasticity and a plurality of hard layers having rigidity, and a covering layer covering an outer peripheral part of the laminate. The soft layer comprises a rubber composition containing a polychloroprene, and the covering layer comprises a blend rubber composition containing a polychloroprene in an amount of 30 to 95 parts by mass and an elastomer other than the polychloroprene in an amount of 70 to 5 parts by mass relative to 100 parts by mass of a total amount of the polychloroprene and the elastomer other than the polychloroprene.

The soft layer may comprise a rubber composition containing the polychloroprene in an amount of 50 to 95 parts by mass and an elastomer other than the polychloroprene in an amount of 50 to 5 parts by mass relative to 100 parts by mass of a total amount of the polychloroprene and the elastomer other than the polychloroprene.

The laminate and the covering layer may be bonded by vulcanization adhesion or with an adhesive.

The blend rubber composition of the covering layer may contain a sulfur compound in an amount of 0.1 to 4.0 parts by mass relative to 100 parts by mass of a total amount of the polychloroprene and the elastomer other than the polychloroprene.

The elastomer other than the polychloroprene in the covering layer may be at least one elastomer selected from an ethylene/α-olefin copolymer, an ethylene/α-olefin/nonconjugated polyene copolymer, and a butyl rubber.

The elastomer other than the polychloroprene in the soft layer may be at least one elastomer selected from an ethylene/α-olefin copolymer, an ethylene/α-olefin/nonconjugated polyene copolymer, a butyl rubber, and a diene rubber.

The polychloroprene in the soft layer and the covering layer may be at least one polychloroprene selected from a mercaptan-modified polychloroprene, a xanthogen-modified polychloroprene, and a sulfur-modified polychloroprene.

### Advantageous Effects of Invention

According to the present invention, a rubber bearing, specifically, a rubber bearing having higher ozone resistance can be obtained from a polychloroprene composition.

### DESCRIPTION OF EMBODIMENTS

Embodiments of the present invention will now be described in detail. The present invention is not intended to be limited to the following embodiments.

A rubber bearing pertaining to the present embodiment comprises a laminate prepared by alternately laminating a plurality of hard layers having rigidity, such as steel plates, and a plurality of rubber sheet-like soft layers in the vertical direction and comprises a covering layer covering the outer peripheral part. To install the bearing, an upper plate and a lower plate are attached, and the lower plate is fixed to the ground or a bridge substructure, whereas the upper plate is fixed to a structure such as a building or a bridge superstructure.

“Soft Layer”

Soft layers included in the laminate are provided to allow the rubber bearing to exert low rigidity and large deformability in the horizontal direction. In the present embodiment, a rubber composition containing a polychloroprene is used as the material constituting the soft layer.

The polychloroprene is classified by the type of a molecular weight modifier into a sulfur-modified polychloroprene, a mercaptan-modified polychloroprene, and a xanthogen-modified polychloroprene. As the polychloroprene used in the embodiment, a polychloroprene modified by any method can be used, but the sulfur-modified polychloroprene or the mercaptan-modified polychloroprene is preferably used. Such a polychloroprene has excellent vulcanization adhesiveness to metal, and thus a rubber bearing comprising the polychloroprene obtains excellent durability.

The rubber composition of the soft layer may contain an elastomer other than the polychloroprene in order to improve the ozone resistance of the resulting laminate. The elastomer other than the polychloroprene is preferably an ethylene/α-olefin copolymer, an ethylene/α-olefin/nonconjugated polyene copolymer, and a butyl rubber. These elastomers other than the polychloroprene may be used singly or in combination of two or more of them.

The α-olefin in the ethylene/α-olefin copolymer and the ethylene/α-olefin/nonconjugated polyene copolymer is preferably an α-olefin having 3 to 20 carbon atoms from the viewpoint of processability. Examples of the α-olefin having 3 to 20 carbon atoms include propylene, 1-butene, 1-pentene, 1-hexene, 1-heptene, 1-octene, and 1-decene.

Of these α-olefins, propylene, 1-butene, 1-hexene, and 1-octene are preferred, and propylene is particularly preferred, from the viewpoint of the balance of processability and heat resistance. The α-olefin included in the ethylene/α-olefin copolymer and the ethylene/α-olefin/nonconjugated polyene copolymer is not limited to a single type of α-olefin, and two or more types of α-olefins may be copolymerized.

Examples of the nonconjugated polyene included in the ethylene/α-olefin/nonconjugated polyene copolymer include cyclic polyenes such as 5-ethylidene-2-norbornene, dicyclopentadiene, 5-propylidene-2-norbornene, 5-vinyl-2-norbornene, 2,5-norbornadiene, 1,4-cyclohexadiene, 1,4-cyclooctadiene, and 1,5-cyclooctadiene; linear polyenes having 6 to 15 carbon atoms and internal unsaturated bonds such as 1,4-hexadiene, 4-methyl-1,4-hexadiene, 5-methyl-1,4-hexadiene, 5-methyl-1,5-heptadiene, 6-methyl-1,5-heptadiene, 6-methyl-1,6-octadiene, 7-methyl-1,6-octadiene, 5,7-dimethyl-1,6-octadiene, 7-methyl-1,7-nonadiene, 8-methyl-1,7-nonadiene, 8-methyl-1,8-decadiene, 9-methyl-1,8-decadiene, 4-ethylidene-1,6-octadiene, 7-methyl-4-ethylidene-1,6-octadiene, 7-methyl-4-ethylidene-1,6-nonadiene, 7-ethyl-4-ethylidene-1,6-nonadiene, 6,7-dimethyl-4-ethylidene-1,6-octadiene, and 6,7-dimethyl-4-ethylidene-1,6-nonadiene; and α,α-dienes such as 1,5-hexadiene, 1,6-heptadiene, 1,7-octadiene, 1,8-nonadiene, 1,9-decadiene, 1,10-undecadiene, 1,11-dodecadiene, 1,12-tridecadiene, and 1,13-tetradecadiene.

Of these nonconjugated polyenes, 5-ethylidene-2-norbornene, dicyclopentadiene, 5-vinyl-2-norbornene, 7-methyl-1,6-octadiene, and 5-methyl-1,4-hexadiene are preferred, and 5-ethylidene-2-norbornene is particularly preferred, from the viewpoint of cross-linking efficiency. The nonconjugated polyene included in the ethylene/α-olefin/nonconjugated polyene copolymer is not limited to a single type of nonconjugated polyene, and two or more types of nonconjugated polyenes may be copolymerized.

The above ethylene/α-olefin copolymer and the ethylene/α-olefin/nonconjugated polyene copolymer can be produced by copolymerizing ethylene with an α-olefin and, as needed, a nonconjugated polyene by a conventionally known method such as vapor phase polymerization, solution polymerization, and slurry polymerization.

The butyl rubber is exemplified by a butyl rubber, a halogenated butyl rubber, and a brominated isobutylene/p-methylstyrene. As the halogenated butyl rubber, a chlorinated butyl rubber (Cl-IIR) and a brominated butyl rubber (Br-IIR) can be used, for example. These butyl rubbers may be used singly or in combination of two or more of them.

As for the amounts of the polychloroprene and the elastomer other than the polychloroprene, the amount of the polychloroprene is preferably 50 to 95 parts by mass, and the amount of the elastomer other than the polychloroprene is preferably 50 to 5 parts by mass, relative to 100 parts by mass of the total amount of the polychloroprene and the elastomer other than the polychloroprene. When containing the elastomer other than the polychloroprene in an amount of 5 parts by mass or more, the soft layer obtains higher ozone resistance. When the elastomer other than the polychloroprene is contained in an amount of 50 parts by mass or less, the compatibility with the polychloroprene is further improved, and the soft layer is more easily vulcanized.

The rubber composition of the soft layer may contain a diene rubber in order to prevent the rubber composition from adhering to kneading rolls or to improve the adhesiveness to the covering layer.

The diene rubber is exemplified by a butadiene rubber, a styrene-butadiene copolymer rubber (SBR), a butyl rubber, a halogenated butyl rubber, and a brominated isobutylene/p-methylstyrene. As the halogenated butyl rubber, a chlorinated butyl rubber (Cl-IIR) and a brominated butyl rubber (Br-IIR) can be used. These diene rubbers may be used singly or in combination of two or more of them.

As for the amounts of the polychloroprene and the diene rubber, the amount of the polychloroprene is preferably 50 to 95 parts by mass, and the amount of the diene rubber is preferably 50 to 5 parts by mass, relative to 100 parts by mass of the total amount of the polychloroprene and the elastomer other than the polychloroprene. When the soft layer contains the diene rubber in an amount of 5 parts by mass or more, the adhesion to kneading rolls can be more effectively suppressed, and the adhesive strength to the hard layer can be more effectively improved. When the diene rubber is contained in an amount of 50 parts by mass or less, the compatibility with the polychloroprene is further improved, and the soft layer is more easily vulcanized.

The rubber composition of the soft layer may contain carbon black, silica, an ozone antioxidant, a thermal antioxidant, and a plasticizer, for example.

The carbon black is exemplified by thermal black and acetylene black produced by thermal decomposition and furnace black and channel black produced by incomplete combustion, and any of them can be used. Of them, furnace black is particularly preferred due to large reinforcing effect on the polychloroprene.

The amount of the carbon black is preferably 10 to 60 parts by mass relative to 100 parts by mass of the polychloroprene in the rubber composition. When the carbon black is contained in an amount of 10 parts by mass or more, the tensile strength and the modulus of the soft layer are further improved. When the carbon black is contained in an amount of 60 parts by mass or less, the rubber composition is unlikely to scorch, and the deterioration of processability or the increase in brittleness temperature of the soft layer can be suppressed. The amount of the carbon black is more preferably 20 to 60 parts by mass and even more preferably 20 to 50 parts by mass relative to 100 parts by mass of the polychloroprene in the rubber composition from the viewpoint of mechanical properties and processability of the soft layer.

As the silica, a silica usable as the filler for reinforcing a polychloroprene, such as wet silica, dry silica, and colloidal silica, can be appropriately selected and used. Of these silicas, a silica having a BET specific surface area of 50 m²/g or more, which is determined in accordance with ISO 5794/1, is preferably used, and a silica having a BET specific surface area of 100 m²/g or more is more preferably used, from the viewpoint of particularly improving reinforcing effect and the effect of suppressing heat generation. Such a silica is exemplified by “Nipsil AQ” (BET specific surface area: 190 m²/g) and “Nipsil VN3” manufactured by Tosoh Silica Corporation and “Ultrasil VN3” (BET specific surface area: 175 m²/g) manufactured by Degussa.

The amount of the silica is preferably 5 to 50 parts by mass relative to 100 parts by mass of the polychloroprene in the rubber composition. When the silica is contained in an amount of 5 parts by mass or more, the reinforcing effect is further improved. When the silica is contained in an amount of 50 parts by mass or less, the dispersibility can be prevented from lowering to give uniform products, or the processability can be prevented from rapidly deteriorating. The amount of the silica is more preferably 10 to 40 parts by mass relative to 100 parts by mass of the polychloroprene in the rubber composition from the viewpoint of giving sufficient reinforcing effect and processing safety. Here, the “processing safety” is a processing character evaluated by a scorch time and greatly affects a failure rate. Specifically, when a composition having a short scorch time is molded at high temperature, an unvulcanized polychloroprene component is vulcanized to increase the rate of molding failure.

The ozone antioxidant has an effect of suppressing the degradation of the polychloroprene in the soft layer by ozone. Such an ozone antioxidant is exemplified by an amine antioxidant.

Examples of the amine antioxidant include N-phenyl-N′-isopropyl-p -phenylenediamine, N-phenyl-N′-(1,3-dimethylbutyl)-p-phenylenediamine, N-phenyl-N′-(3-methacryloyloxy-2-hydroxypropyl)-p-phenylenediamine, N, N′-bis-(1,4-dimethylphenyl)-p-phenylenediamine, 6-ethoxy-1,2-dihydro-2,2,4-trimethylquinoline, nickel diethyldithiocarbamate, nickel dibutyldithiocarbamate, 1,3-bis(dimethylaminopropyl)-2-thiourea, and tributylthiourea. These amine antioxidants may be used in combination of two or more of them.

The amount of the ozone antioxidant is preferably in a range of 0.5 to 10 parts by mass relative to 100 parts by mass of the polychloroprene in the rubber composition. When containing the ozone antioxidant in an amount of 0.5 part by mass or more, the rubber composition obtains higher ozone deterioration prevention effect. When the ozone antioxidant is contained in an amount of 10 parts by mass or less, vulcanization inhibition or the bleeding out of the ozone antioxidant is more unlikely to occur to suppress the deterioration of various physical properties including heat resistance, and better products can be produced when the composition is vulcanized or molded.

The thermal antioxidant has an effect of suppressing the degradation of the polychloroprene in the soft layer by heat. Such a thermal antioxidant is exemplified by an aromatic amine antioxidant, a hindered phenol antioxidant, and a phosphorous acid antioxidant.

Examples of the aromatic amine antioxidant include N-phenyl-1-naphthylamine, alkylated diphenylamines, octylated diphenylamine, 4,4′-bis(α,α-dimethylbenzyl)diphenylamine, p-(p-toluenesulfonylamide)diphenylamine, N,N′-di-2-naphthyl-p-phenylenediamine, and N,N′-diphenyl-p-phenylenediamine. These antioxidants may be used in combination of two or more of them.

Examples of the hindered phenol antioxidant include 1,1,3-tris-(2-methyl-4-hydroxy-5-tert-butylphenyl)butane, 4,4′-butylidene-bis-(3-methyl-6-tert-butylphenol), 2,2-thio-bis(4-methyl-6-tert-butylphenol), 7-octadecyl-3-(4′-hydroxy-3′,5′-di-tert-butylphenyl) propionate, tetrakis-[methylene-3-(3′,5′-di-tert-butyl-4′-hydroxyphenyl) propionate]methane, pentaerythritol-tetrakis[3-(3,5-di-tert-butyl-4-hydroxyphenyl) propionate], triethylene glycol-bis[3-(3-tert-butyl-5-methyl-4-hydroxyphenyl) propionate], 1,6-hexanediol-bis [3-(3,5-di-tert-butyl-4-hydroxyphenyl) propionate], 2,4-bis(n-octylthio)-6-(4-hydroxy-3,5-di-tert-butylanilino)-1,3,5-triazine, tris-(3,5-di-tert-butyl-4-hydroxybenzyl) isocyanurate, 2,2-thio-diethylene bis[3-(3,5-di-tert-butyl-4-hydroxyphenyl) propionate], N,N′-hexamethylene bis(3,5-di-tert-butyl-4-hydroxy)-hydrocinnamide, 2,4-bis[(octylthio)methyl]-o-cresol, 3,5-di-tert-butyl-4-hydroxybenzylphosphonate diethyl ester, tetrakis [methylene(3,5-di-tert-butyl-4-hydroxyhydrocinnamate)]methane, octadecyl 3-(3,5-di-tert-butyl-4-hydroxyphenyl)propionic acid ester, and 3,9-bis[2-{3-(3-tert-butyl-4-hydroxy-5-methylphenyl)propionyloxy}-1,1-dimethylethyl]-2,4,8,10-tetraoxaspiro[5.5]undecane. These antioxidants may be used in combination of two or more of them.

Examples of the phosphorous acid antioxidant include tris(nonylphenyl) phosphite, tris(mono- and di-nonylphenyl) phosphite, diphenylmono(2-ethylhexyl) phosphite, diphenylmonotridecyl phosphite, diphenylisodecyl phosphite, diphenylisooctyl phosphite, diphenylnonylphenyl phosphite, triphenyl phosphite, tris(tridecyl) phosphite, triisodecyl phosphite, tris(2-ethylhexyl) phosphite, tris(2,4-di-tert-butylphenyl) phosphite, tetraphenyl dipropylene glycol diphosphite, tetraphenyl tetra(tridecyl)pentaerythritol tetraphosphite, 1,1,3-tris(2-methyl-4-di-tridecyl phosphite 5-tert-butylphenyl)butane, 4,4′-butylidene-bis(3-methyl-6-tert-butyl-di-tridecyl phosphite), 2,2′-ethylidene-bis(4,6-di-tert-butylphenol) fluorophosphite, 4,4′-isopropylidene-diphenol-alkyl (C12 to C15) phosphite, cyclic neopentanetetrayl bis(2,4-di-tert-butylphenyl phosphite), cyclic neopentanetetrayl bis(2,6-di-tert-butyl-4-phenyl phosphite), cyclic neopentanetetrayl bis(nonylphenyl phosphite), bis(nonylphenyl)pentaerythritol diphosphite, dibutyl hydrogenphosphite, distearyl pentaerythritol diphosphite, and hydrogenated bisphenol A/pentaerythritol phosphite polymers. These antioxidants may be used in combination of two or more of them.

Such a thermal antioxidant is preferably contained in an amount ranging from 0.5 to 10 parts by mass relative to 100 parts by mass of the polychloroprene in the rubber composition. When containing the thermal antioxidant in an amount of 0.5 part by mass or more, the rubber composition obtains higher thermal degradation prevention effect. When the thermal antioxidant is contained in an amount of 10 parts by mass or less, vulcanization inhibition or the bleeding out of the thermal antioxidant is more unlikely to occur, and better products can be produced when the composition is vulcanized or molded.

The plasticizer has an effect of reducing the brittleness temperature of a rubber composition to be obtained when the rubber composition is vulcanized and of controlling the static shear modulus thereof. The plasticizer to be contained in the rubber composition is exemplified by dialkyl sebacates, dialkyl azelates, and dialkyl adipates.

Of these plasticizers, dibutyl sebacate, dioctyl sebacate, and dimethyl sebacate as the dialkyl sebacate, dioctyl azelate as the dialkyl azelate, and dioctyl adipate, diisodecyl adipate, and diisobutyl adipate as the dialkyl adipate are particularly preferably used because such a plasticizer effectively reduces the brittleness temperature of the rubber composition to be obtained.

When added, the plasticizer is preferably contained in an amount of 1 to 20 parts by mass relative to 100 parts by mass of the polychloroprene in the rubber composition. When the plasticizer is contained in such a range, the effect of reducing the brittleness temperature is further improved.

The rubber composition of the soft layer may contain additives such as a vulcanizing agent and a vulcanization accelerator as needed.

The vulcanizing agent is not limited to particular agents, but is preferably a metal oxide, and is specifically exemplified by zinc oxide, magnesium oxide, lead oxide, trilead tetroxide, iron sesquioxide, titanium dioxide, and calcium oxide. These vulcanizing agents may be used in combination of two or more of them. Combination use of the vulcanizing agent with the vulcanization accelerator described later enables more efficient vulcanization. The amount of such a vulcanizing agent is preferably 2 to 10 parts by mass relative to 100 parts by mass of the polychloroprene in the rubber composition.

As the vulcanization accelerator, thiourea, guanidine, thiuram, and thiazole vulcanization accelerators that are typically used for the vulcanization of the polychloroprene in a rubber composition can be used, and specifically, the thiourea vulcanization accelerator is preferred. The thiourea vulcanization accelerator is exemplified by ethylene thiourea, diethylthiourea, trimethylthiourea, and N,N′-diphenylthiourea, and specifically, trimethylthiourea is preferred. These vulcanization accelerators may be used in combination of two or more of them. The amount of such a vulcanization accelerator is preferably 0.5 to 5 parts by mass relative to 100 parts by mass of the polychloroprene in the rubber composition.

The rubber composition of the soft layer can be kneaded with a kneading machine such as a kneader, a banbury mixer, and a roll mixer, then molded into an intended shape, and vulcanized to give a soft layer, in a similar manner to that for a typical polychloroprene. Specifically, components are kneaded, and the kneaded material is molded into an intended shape and vulcanized. The vulcanization temperature and the vulcanization time can be appropriately set. The vulcanization temperature is preferably 120 to 180° C. and more preferably 130 to 160° C.

“Hard Layer”

Hard layers included in the laminate are provided to allow the rubber bearing to exert high rigidity and high strength in the vertical direction. The material constituting the hard layers may be any material having higher hardness than the soft layers. For example, metal plates such as rolled steel plates and iron plates, ceramic plates, and rigid plastic plates are used, and specifically, rolled steel plates and iron plates are preferably used.

“Laminate”

To prepare the laminate, a plurality of the soft layers and the hard layers are prepared and are set in a mold so as to give an intended arrangement. The soft layers and the hard layers to be set in a mold may be coated with an adhesive previously. Next, press vulcanization is performed to heat and vulcanize the soft layers and the hard layers.

“Covering Layer”

The covering layer covers the outer peripheral part of the laminate in order to improve the ozone resistance of the laminate. In the present embodiment, a blend rubber composition containing a polychloroprene and an elastomer other than the polychloroprene is used as the material constituting the covering layer. The polychloroprene and the elastomer other than the polychloroprene contained in the blend rubber composition may be the same materials as those of the polychloroprene and the elastomer other than the polychloroprene contained in the rubber composition of the soft layer. To bond the covering layer to the laminate, the polychloroprene is preferably a polychloroprene modified with the same substance as in the soft layer.

As for the amounts of the polychloroprene and the elastomer other than the polychloroprene, the amount of the polychloroprene is 30 to 95 parts by mass, and the amount of the elastomer other than the polychloroprene is 70 to 5 parts by mass, relative to 100 parts by mass of the total amount of the polychloroprene and the elastomer other than the polychloroprene. When the covering layer contains the elastomer other than the polychloroprene in an amount of less than 5 parts by mass, the effect of improving the ozone resistance of the covering layer may not be achieved. When the elastomer other than the polychloroprene is contained in an amount of more than 70 parts by mass, the vulcanization adhesion face between soft layers and a covering layer may be separated.

The blend rubber composition of the covering layer may contain a sulfur compound in an amount of 0.1 to 4.0 parts by mass relative to 100 parts by mass of the total amount of the polychloroprene and the elastomer other than the polychloroprene. When the sulfur compound is added, the polychloroprene and the elastomer other than the polychloroprene in the covering layer are co-crosslinked, and thus the durability of a rubber bearing to be produced can be further improved.

When the sulfur compound is contained in an amount of 0.1 part by mass or more, the above effect is readily achieved. When the sulfur compound is contained in an amount of 4.0 parts by mass or less, a rubber bearing to be produced obtains higher heat resistance. The amount of the sulfur compound is preferably in a range of 0.5 to 1.5 parts by mass from the viewpoint of improving the durability and of maintaining the heat resistance of the rubber bearing.

Examples of the sulfur compound include sulfur, 2-(morpholinodithio)b enzothiazole, 4,4′-dithiodimorpholine, tetramethylthiuram disulfide, tetraethylthiuram disulfide, tetrabutylthiuram disulfide, tetrakis(2-ethylhexyl)thiuram disulfide, tetrabenzylthiuram disulfide, and dip entamethylenethiuram tetrasulfide.

The blend rubber composition of the covering layer may contain carbon black, silica, an ozone antioxidant, a thermal antioxidant, and a plasticizer, as with the rubber composition of the soft layer.

The carbon black is exemplified by thermal black and acetylene black produced by thermal decomposition and furnace black and channel black produced by incomplete combustion, and any of them can be used. Of them, furnace black is particularly preferred due to large reinforcing effect on the polychloroprene.

The amount of the carbon black is preferably 10 to 60 parts by mass relative to 100 parts by mass of the polychloroprene in the blend rubber composition. When the carbon black is contained in an amount of 10 parts by mass or more, the tensile strength and the modulus of the covering layer are further improved. When the carbon black is contained in an amount of 60 parts by mass or less, the blend rubber composition is unlikely to scorch, and the deterioration of processability or the increase in brittleness temperature of the covering layer can be suppressed. The amount of the carbon black is more preferably 20 to 60 parts by mass and even more preferably 20 to 50 parts by mass relative to 100 parts by mass of the polychloroprene in the blend rubber composition from the viewpoint of mechanical properties and processability of the covering layer.

As the silica, a silica usable as the filler for reinforcing a polychloroprene, such as wet silica, dry silica, and colloidal silica, can be appropriately selected and used. Of these silicas, a silica having a BET specific surface area of 50 m²/g or more, which is determined in accordance with ISO 5794/1, is preferably used, and a silica having a BET specific surface area of 100 m²/g or more is more preferably used, from the viewpoint of particularly improving reinforcing effect and the effect of suppressing heat generation. Such a silica is exemplified by “Nipsil AQ” (BET specific surface area: 190 m²/g) and “Nipsil VN3” manufactured by Tosoh Silica Corporation and “Ultrasil VN3” (BET specific surface area: 175 m²/g) manufactured by Degussa.

The amount of the silica is preferably 5 to 50 parts by mass relative to 100 parts by mass of the polychloroprene in the blend rubber composition. When the silica is contained in an amount of 5 parts by mass or more, the reinforcing effect is further improved. When the silica is contained in an amount of 50 parts by mass or less, the dispersibility can be prevented from lowering to give uniform products, or the processability can be prevented from rapidly deteriorating. The amount of the silica is more preferably 10 to 40 parts by mass relative to 100 parts by mass of the polychloroprene in the blend rubber composition from the viewpoint of giving sufficient reinforcing effect and processing safety. Here, the “processing safety” is a processing character evaluated by a scorch time and greatly affects a failure rate. Specifically, when a composition having a short scorch time is molded at high temperature, an unvulcanized polychloroprene component is vulcanized to increase the rate of molding failure.

The ozone antioxidant has an effect of suppressing the degradation of the polychloroprene in the covering layer by ozone. Such an ozone antioxidant is exemplified by an amine antioxidant.

Examples of the amine antioxidant include N-phenyl-N′-isopropyl-p-phenylenediamine, N-phenyl-N′-(1,3-dimethylbutyl)-p-phenylenediamine, N-phenyl-N′-(3-methacryloyloxy-2-hydroxypropyl)-p-phenylenediamine, N,N′-bis-(1,4-dimethylphenyl)-p-phenylenediamine, 6-ethoxy-1,2-dihydro-2,2,4-trimethylquinoline, nickel diethyldithiocarbamate, nickel dibutyldithiocarbamate, 1,3-bis(dimethylaminopropyl)-2-thiourea, and tributylthiourea. These amine antioxidants may be used in combination of two or more of them.

The amount of the ozone antioxidant is preferably in a range of 0.5 to 10 parts by mass relative to 100 parts by mass of the polychloroprene in the blend rubber composition. When containing the ozone antioxidant in an amount of 0.5 part by mass or more, the blend rubber composition obtains higher ozone deterioration prevention effect. When the ozone antioxidant is contained in an amount of 10 parts by mass or less, vulcanization inhibition or the bleeding out of the ozone antioxidant is more unlikely to occur to suppress the deterioration of various physical properties including heat resistance, and better products can be produced when the composition is vulcanized or molded.

The thermal antioxidant has an effect of suppressing the degradation of the polychloroprene in the covering layer by heat. Such a thermal antioxidant is exemplified by an aromatic amine antioxidant, a hindered phenol antioxidant, and a phosphorous acid antioxidant.

Examples of the aromatic amine antioxidant include N-phenyl-1-naphthylamine, alkylated diphenylamines, octylated diphenylamine, 4,4′-bis(α,α-dimethylbenzyl)diphenylamine, p-(p-toluenesulfonylamide)diphenylamine, N,N′-di-2-naphthyl-p-phenylenediamine, and N,N′-diphenyl-p-phenylenediamine. These antioxidants may be used in combination of two or more of them.

Examples of the hindered phenol antioxidant include 1,1,3-tris-(2-methyl-4-hydroxy-5-tert-butylphenyl)butane, 4, 4′-butylidene-bis-(3-methyl-6-tert-butylphenol), 2,2-thio-bis(4-methyl-6-tert-butylphenol), 7-octadecyl-3-(4′-hydroxy-3′,5′-di-tert-butylphenyl) propionate, tetrakis-[methylene-3-(3′, 5′-di-tert-butyl-4′-hydroxyphenyl) propionate]methane, pentaerythritol-tetrakis[3-(3,5-di-tert-butyl-4-hydroxyphenyl) propionate], triethylene glycol-bis[3-(3-tert-butyl-5-methyl-4-hydroxyphenyl) propionate], 1,6-hexanediol-bis [3-(3,5-di-tert-butyl-4-hydroxyphenyl)propionate], 2,4-bis(n-octylthio)-6-(4-hydroxy-3,5-di-tert-butylanilino)-1,3,5-triazine, tris-(3,5-di-tert-butyl-4-hydroxybenzyl) isocyanurate, 2,2-thio-diethylene-bis[3-(3,5-di-tert-butyl-4-hydroxyphenyl) propionate], N,N′-hexamethylene-bis(3,5-di-tert-butyl-4-hydroxy)-hydrocinnamide, 2,4-bis[(octylthio)methyl]-o-cresol, 3,5-di-tert-butyl-4-hydroxybenzylphosphonate diethyl ester, tetrakis [methylene(3,5-di-tert-butyl-4-hydroxyhydrocinnamate)]methane, octadecyl 3-(3,5-di-tert-butyl-4-hydroxyphenyl)propionic acid ester, and 3,9-bis[2-{3-(3-tert-butyl-4-hydroxy-5-methylphenyl)propionyloxy}-1,1-dimethylethyl]-2,4,8,10-tetraoxaspiro[5.5]undecane. These antioxidants may be used in combination of two or more of them.

Examples of the phosphorous acid antioxidant include tris(nonylphenyl) phosphite, tris(mono- and di-nonylphenyl) phosphite, diphenylmono(2-ethylhexyl) phosphite, diphenylmonotridecyl phosphite, diphenylisodecyl phosphite, diphenylisooctyl phosphite, diphenylnonylphenyl phosphite, triphenyl phosphite, tris(tridecyl) phosphite, triisodecyl phosphite, tris(2-ethylhexyl) phosphite, tris(2,4-di-tert-butylphenyl) phosphite, tetraphenyl dipropylene glycol diphosphite, tetraphenyl tetra(tridecyl)pentaerythritol tetraphosphite, 1,1,3-tris(2-methyl-4-di-tridecyl phosphite 5-tert-butylphenyl)butane, 4,4′-butylidene-bis(3-methyl-6-tert-butyl-di-tridecyl phosphite), 2,2′-ethylidene-bis(4,6-di-tert-butylphenol) fluorophosphite, 4,4′-isopropylidene-diphenol-alkyl (C12 to C15) phosphite, cyclic neopentanetetrayl bis(2,4-di-tert-butylphenyl phosphite), cyclic neopentanetetrayl bis(2,6-di-tert-butyl-4-phenyl phosphite), cyclic neopentanetetrayl bis(nonylphenyl phosphite), bis(nonylphenyl)pentaerythritol diphosphite, dibutyl hydrogenphosphite, distearyl pentaerythritol diphosphite, and hydrogenated bisphenol A/pentaerythritol phosphite polymers. These antioxidants may be used in combination of two or more of them.

Such a thermal antioxidant is preferably contained in an amount ranging from 0.5 to 10 parts by mass relative to 100 parts by mass of the polychloroprene in the blend rubber composition. When containing the thermal antioxidant in an amount of 0.5 part by mass or more, the blend rubber composition obtains higher thermal degradation prevention effect. When the thermal antioxidant is contained in an amount of 10 parts by mass or less, vulcanization inhibition or the bleeding out of the thermal antioxidant is more unlikely to occur, and better products can be produced when the composition is vulcanized or molded.

The plasticizer has an effect of reducing the brittleness temperature of a blend rubber composition to be obtained when the blend rubber composition is vulcanized and of controlling the static shear modulus thereof. The plasticizer to be contained in the blend rubber composition is exemplified by dialkyl sebacates, dialkyl azelates, and dialkyl adipates.

Of these plasticizers, dibutyl sebacate, dioctyl sebacate, and dimethyl sebacate as the dialkyl sebacate, dioctyl azelate as the dialkyl azelate, and dioctyl adipate, diisodecyl adipate, and diisobutyl adipate as the dialkyl adipate are particularly preferably used because such a plasticizer effectively reduces the brittleness temperature of the blend rubber composition to be obtained.

When added, the plasticizer is preferably contained in an amount of 1 to 20 parts by mass relative to 100 parts by mass of the polychloroprene in the blend rubber composition. When the plasticizer is contained in such a range, the effect of reducing the brittleness temperature is further improved.

The rubber composition of the covering layer may contain additives such as a vulcanizing agent and a vulcanization accelerator as needed.

The vulcanizing agent is not limited to particular agents, but is preferably a metal oxide, and is specifically exemplified by zinc oxide, magnesium oxide, lead oxide, trilead tetroxide, iron sesquioxide, titanium dioxide, and calcium oxide. These vulcanizing agents may be used in combination of two or more of them. Combination use of the vulcanizing agent with the vulcanization accelerator described later enables more efficient vulcanization. The amount of such a vulcanizing agent is preferably 2 to 10 parts by mass relative to 100 parts by mass of the polychloroprene in the blend rubber composition.

As the vulcanization accelerator, thiourea, guanidine, thiuram, and thiazole vulcanization accelerators that are typically used for the vulcanization of the polychloroprene in a blend rubber composition can be used, and specifically, the thiourea vulcanization accelerator is preferred. The thiourea vulcanization accelerator is exemplified by ethylene thiourea, diethylthiourea, trimethylthiourea, and N,N′-diphenylthiourea, and specifically, trimethylthiourea is preferred. These vulcanization accelerators may be used in combination of two or more of them. The amount of such a vulcanization accelerator is preferably 0.5 to 5 parts by mass relative to 100 parts by mass of the polychloroprene in the blend rubber composition.

The blend rubber composition of the covering layer can be kneaded with a kneading machine such as a kneader, a banbury mixer, and a roll mixer, then molded into an intended shape, and vulcanized to give a covering layer, in a similar manner to that for a typical polychloroprene. Specifically, components are kneaded, and the kneaded material is molded into an intended shape and vulcanized. The vulcanization temperature and the vulcanization time can be appropriately set. The vulcanization temperature is preferably 120 to 180° C. and more preferably 130 to 160° C.

To produce the rubber bearing, the covering layer can be tightly wound on the outer peripheral part of the laminate, and the whole can be subjected to vulcanization adhesion to be integrated. Alternatively, these members can be integrated with an adhesive.

### EXAMPLES

Advantageous effects of the present invention will next be described with reference to production examples and examples. In each production example, the type and the amount of a polychloroprene, an elastomer other than the polychloroprene (hereinafter called “elastomer”), a carbon black, and an antioxidant were changed, and a rubber composition of the soft layer and a blend rubber composition of the covering layer were prepared and evaluated.

TABLE 1

| | | | | | Production Example | | | | | | | |
|---|---|---|---|---|---|---|---|---|---|---|---|---|
| | | | | Unit | 1 | 2 | 3 | 4 | 5 | 6 | 7 | 8 |
| Formulation | Soft | Polychloroprene | Polychloroprene 1 | Parts by mass | 100 | | | 70 | 70 | 100 | 100 | 100 |
| | layer | | Polychloroprene 2 | Parts by mass | | 100 | | | | | | |
| | | | Polychloroprene 3 | Parts by mass | | | 100 | | | | | |
| | | Natural rubber | | Parts by mass | | | | | | | | |
| | | Styrene/butadiene | | Parts by mass | | | | | | | | |
| | | copolymer rubber | | | | | | | | | | |
| | | Elastomer | Elastomer 1 | Parts by mass | | | | 30 | | | | |
| | | | Elastomer 2 | Parts by mass | | | | | 30 | | | |
| | | Carbon black | Carbon black 1 | Parts by mass | 40 | 40 | 40 | 40 | 40 | | 40 | 40 |
| | | | Carbon black 2 | Parts by mass | | | | | | 40 | | |
| | | Antioxidant | Antioxidant 1 | Parts by mass | 0.5 | 0.5 | 0.5 | 0.5 | 0.5 | 0.5 | | 0.5 |
| | | | Antioxidant 2 | Parts by mass | | | | | | | 0.5 | |
| | | Plasticizer | Plasticizer 1 | Parts by mass | 15 | 15 | 15 | 15 | 15 | 15 | 15 | |
| | | | Plasticizer 2 | Parts by mass | | | | | | | | 15 |
| | | | Plasticizer 3 | Parts by mass | | | | | | | | |
| | Covering | Polychloroprene | Polychloroprene 1 | Parts by mass | 70 | 70 | 70 | 70 | 70 | 70 | 70 | 70 |
| | layer | | Polychloroprene 2 | Parts by mass | | | | | | | | |
| | | | Polychloroprene 3 | Parts by mass | | | | | | | | |
| | | Elastomer | Elastomer 1 | Parts by mass | 30 | 30 | 30 | 30 | 30 | 30 | 30 | 30 |
| | | | Elastomer 2 | Parts by mass | | | | | | | | |
| | | Sulfur compound | Sulfur | Parts by mass | 0.5 | 0.5 | 0.5 | 0.5 | 0.5 | 0.5 | 0.5 | 0.5 |
| | | | compound 1 | | | | | | | | | |
| | | | Sulfur | Parts by mass | | | | | | | | |
| | | | compound 2 | | | | | | | | | |
| | | | Sulfur | Parts by mass | | | | | | | | |
| | | | compound 3 | | | | | | | | | |
| | | | Sulfur | Parts by mass | | | | | | | | |
| | | | compound 4 | | | | | | | | | |
| | | Carbon black | Carbon black 1 | Parts by mass | 30 | 30 | 30 | 30 | 30 | 30 | 30 | 30 |
| | | | Carbon black 2 | Parts by mass | | | | | | | | |
| | | Antioxidant | Antioxidant 1 | Parts by mass | 0.5 | 0.5 | 0.5 | 0.5 | 0.5 | 0.5 | 0.5 | 0.5 |
| | | | Antioxidant 2 | Parts by mass | | | | | | | | |
| | | Plasticizer | Plasticizer 1 | Parts by mass | 5 | 5 | 5 | 5 | 5 | 5 | 5 | 5 |
| | | | Plasticizer 2 | Parts by mass | | | | | | | | |
| | | | Plasticizer 3 | Parts by mass | | | | | | | | |
| Evaluation | Ozone resistance | | | | ◯ | ◯ | ◯ | ◯ | ◯ | ◯ | ◯ | ◯ |
| | Vulcanization adhesiveness between | | | | ◯ | ◯ | ◯ | ◯ | ◯ | ◯ | ◯ | ◯ |
| | soft layer and covering layer | | | | | | | | | | | |
| | | | | | Production Example | | | | | | | |
| | | | | Unit | 9 | 10 | 11 | 12 | 13 | 14 | 15 | 16 |
| Formulation | Soft | Polychloroprene | Polychloroprene 1 | Parts by mass | 100 | 100 | 100 | 100 | 100 | 100 | 100 | 100 |
| | layer | | Polychloroprene 2 | Parts by mass | | | | | | | | |
| | | | Polychloroprene 3 | Parts by mass | | | | | | | | |
| | | Natural rubber | | Parts by mass | | | | | | | | |
| | | Styrene/butadiene | | Parts by mass | | | | | | | | |
| | | copolymer rubber | | | | | | | | | | |
| | | Elastomer | Elastomer 1 | Parts by mass | | | | | | | | |
| | | | Elastomer 2 | Parts by mass | | | | | | | | |
| | | Carbon black | Carbon black 1 | Parts by mass | 40 | 40 | 40 | 40 | 40 | 40 | 40 | 40 |
| | | | Carbon black 2 | Parts by mass | | | | | | | | |
| | | Antioxidant | Antioxidant 1 | Parts by mass | 0.5 | 0.5 | 0.5 | 0.5 | 0.5 | 0.5 | 0.5 | 0.5 |
| | | | Antioxidant 2 | Parts by mass | | | | | | | | |
| | | Plasticizer | Plasticizer 1 | Parts by mass | | 15 | 15 | 15 | 15 | 15 | 15 | 15 |
| | | | Plasticizer 2 | Parts by mass | | | | | | | | |
| | | | Plasticizer 3 | Parts by mass | 15 | | | | | | | |
| | Covering | Polychloroprene | Polychloroprene 1 | Parts by mass | 70 | 30 | 95 | | | 70 | 70 | 70 |
| | layer | | Polychloroprene 2 | Parts by mass | | | | 70 | | | | |
| | | | Polychloroprene 3 | Parts by mass | | | | | 70 | | | |
| | | Elastomer | Elastomer 1 | Parts by mass | 30 | 70 | 5 | 30 | 30 | | 30 | 30 |
| | | | Elastomer 2 | Parts by mass | | | | | | 30 | | |
| | | Sulfur compound | Sulfur | Parts by mass | 0.5 | 0.5 | 0.5 | 0.5 | 0.5 | 0.5 | | |
| | | | compound 1 | | | | | | | | | |
| | | | Sulfur | Parts by mass | | | | | | | 0.5 | |
| | | | compound 2 | | | | | | | | | |
| | | | Sulfur | Parts by mass | | | | | | | | 0.5 |
| | | | compound 3 | | | | | | | | | |
| | | | Sulfur | Parts by mass | | | | | | | | |
| | | | compound 4 | | | | | | | | | |
| | | Carbon black | Carbon black 1 | Parts by mass | 30 | 30 | 30 | 30 | 30 | 30 | 30 | 30 |
| | | | Carbon black 2 | Parts by mass | | | | | | | | |
| | | Antioxidant | Antioxidant 1 | Parts by mass | 0.5 | 0.5 | 0.5 | 0.5 | 0.5 | 0.5 | 0.5 | 0.5 |
| | | | Antioxidant 2 | Parts by mass | | | | | | | | |
| | | Plasticizer | Plasticizer 1 | Parts by mass | 5 | 5 | 5 | 5 | 5 | 5 | 5 | 5 |
| | | | Plasticizer 2 | Parts by mass | | | | | | | | |
| | | | Plasticizer 3 | Parts by mass | | | | | | | | |
| Evaluation | Ozone resistance | | | | ◯ | ◯ | ◯ | ◯ | ◯ | ◯ | ◯ | ◯ |
| | Vulcanization adhesiveness between | | | | ◯ | ◯ | ◯ | ◯ | ◯ | ◯ | ◯ | ◯ |
| | soft layer and covering layer | | | | | | | | | | | |
| | | | | | Production Example | | | | | | | |
| | | | | Unit | 17 | 18 | 19 | 20 | 21 | 22 | 23 | 24 |
| Formulation | Soft | Polychloroprene | Polychloroprene 1 | Parts by mass | 100 | 100 | 100 | 100 | 100 | 100 | 100 | 100 |
| | layer | | Polychloroprene 2 | Parts by mass | | | | | | | | |
| | | | Polychloroprene 3 | Parts by mass | | | | | | | | |
| | | Natural rubber | | Parts by mass | | | | | | | | |
| | | Styrene/butadiene | | Parts by mass | | | | | | | | |
| | | copolymer rubber | | | | | | | | | | |
| | | Elastomer | Elastomer 1 | Parts by mass | | | | | | | | |
| | | | Elastomer 2 | Parts by mass | | | | | | | | |
| | | Carbon black | Carbon black 1 | Parts by mass | 40 | 40 | 40 | 40 | 40 | 40 | 40 | 40 |
| | | | Carbon black 2 | Parts by mass | | | | | | | | |
| | | Antioxidant | Antioxidant 1 | Parts by mass | 0.5 | 0.5 | 0.5 | 0.5 | 0.5 | 0.5 | 0.5 | 0.5 |
| | | | Antioxidant 2 | Parts by mass | | | | | | | | |
| | | Plasticizer | Plasticizer 1 | Parts by mass | 15 | 15 | 15 | 15 | 15 | 15 | 15 | 15 |
| | | | Plasticizer 2 | Parts by mass | | | | | | | | |
| | | | Plasticizer 3 | Parts by mass | | | | | | | | |
| | Covering | Polychloroprene | Polychloroprene 1 | Parts by mass | 70 | 70 | 70 | 70 | 70 | 70 | 70 | 70 |
| | layer | | Polychloroprene 2 | Parts by mass | | | | | | | | |
| | | | Polychloroprene 3 | Parts by mass | | | | | | | | |
| | | Elastomer | Elastomer 1 | Parts by mass | 30 | 30 | 30 | 30 | 30 | 30 | 30 | 30 |
| | | | Elastomer 2 | Parts by mass | | | | | | | | |
| | | Sulfur compound | Sulfur | Parts by mass | | 0.1 | 1.5 | 4.0 | 0.5 | 0.5 | 0.5 | 0.5 |
| | | | compound 1 | | | | | | | | | |
| | | | Sulfur | Parts by mass | | | | | | | | |
| | | | compound 2 | | | | | | | | | |
| | | | Sulfur | Parts by mass | | | | | | | | |
| | | | compound 3 | | | | | | | | | |
| | | | Sulfur | Parts by mass | 0.5 | | | | | | | |
| | | | compound 4 | | | | | | | | | |
| | | Carbon black | Carbon black 1 | Parts by mass | 30 | 30 | 30 | 30 | | 30 | 30 | 30 |
| | | | Carbon black 2 | Parts by mass | | | | | 30 | | | |
| | | Antioxidant | Antioxidant 1 | Parts by mass | 0.5 | 0.5 | 0.5 | 0.5 | 0.5 | 2 | | 0.5 |
| | | | Antioxidant 2 | Parts by mass | | | | | | | 0.5 | |
| | | Plasticizer | Plasticizer 1 | Parts by mass | 5 | 5 | 5 | 5 | 5 | 5 | 5 | |
| | | | Plasticizer 2 | Parts by mass | | | | | | | | 5 |
| | | | Plasticizer 3 | Parts by mass | | | | | | | | |

| | | | | | | | | | |
|---|---|---|---|---|---|---|---|---|---|
| Evaluation | Ozone resistance | ◯ | ◯ | ◯ | ◯ | ◯ | ◯ | ◯ | ◯ |
| | Vulcanization adhesiveness between | ◯ | ◯ | ◯ | ◯ | ◯ | ◯ | ◯ | ◯ |
| | soft layer and covering layer | | | | | | | | |

| | | | | | Production Example | | | | | | |
|---|---|---|---|---|---|---|---|---|---|---|---|
| | | | | Unit | 25 | A | B | C | D | E | F |
| Formulation | Soft | Polychloroprene | Polychloroprene 1 | Parts by mass | 100 | | | | 100 | 100 | 100 |
| | layer | | Polychloroprene 2 | Parts by mass | | | | | | | |
| | | | Polychloroprene 3 | Parts by mass | | | | | | | |

| | Natural rubber | | Parts by mass | | 100 | | | | | |
|---|---|---|---|---|---|---|---|---|---|---|
| | Styrene/butadiene | | Parts by mass | | | 100 | | | | |
| | copolymer rubber | | | | | | | | | |
| | Elastomer | Elastomer 1 | Parts by mass | | | | 100 | | | |
| | | Elastomer 2 | Parts by mass | | | | | | | |
| | Carbon black | Carbon black 1 | Parts by mass | 40 | 40 | 40 | 40 | 40 | 40 | 40 |
| | | Carbon black 2 | Parts by mass | | | | | | | |
| | Antioxidant | Antioxidant 1 | Parts by mass | 0.5 | 0.5 | 0.5 | 0.5 | 0.5 | 0.5 | 0.5 |
| | | Antioxidant 2 | Parts by mass | | | | | | | |
| | Plasticizer | Plasticizer 1 | Parts by mass | 15 | 15 | 15 | 15 | 15 | 15 | 15 |
| | | Plasticizer 2 | Parts by mass | | | | | | | |
| | | Plasticizer 3 | Parts by mass | | | | | | | |
| Covering | Polychloroprene | Polychloroprene 1 | Parts by mass | 70 | 70 | 70 | 70 | 97 | 100 | 27 |
| layer | | Polychloroprene 2 | Parts by mass | | | | | | | |
| | | Polychloroprene 3 | Parts by mass | | | | | | | |
| | Elastomer | Elastomer 1 | Parts by mass | 30 | 30 | 30 | 30 | 3 | | 73 |
| | | Elastomer 2 | Parts by mass | | | | | | | |
| | Sulfur compound | Sulfur | Parts by mass | 0.5 | 0.5 | 0.5 | 0.5 | 0.5 | 0.5 | 0.5 |
| | | compound 1 | | | | | | | | |
| | | Sulfur | Parts by mass | | | | | | | |
| | | compound 2 | | | | | | | | |
| | | Sulfur | Parts by mass | | | | | | | |
| | | compound 3 | | | | | | | | |
| | | Sulfur | Parts by mass | | | | | | | |
| | | compound 4 | | | | | | | | |
| | Carbon black | Carbon black 1 | Parts by mass | 30 | 30 | 30 | 30 | 30 | 30 | 30 |
| | | Carbon black 2 | Parts by mass | | | | | | | |
| | Antioxidant | Antioxidant 1 | Parts by mass | 0.5 | 0.5 | 0.5 | 0.5 | 0.5 | 0.5 | 0.5 |
| | | Antioxidant 2 | Parts by mass | | | | | | | |
| | Plasticizer | Plasticizer 1 | Parts by mass | | 5 | 5 | 5 | 5 | 5 | 5 |
| | | Plasticizer 2 | Parts by mass | | | | | | | |
| | | Plasticizer 3 | Parts by mass | 5 | | | | | | |

| | | | | | | | | |
|---|---|---|---|---|---|---|---|---|
| Evaluation | Ozone resistance | ◯ | ◯ | ◯ | ◯ | X | X | ◯ |
| | Vulcanization adhesiveness between | ◯ | X | X | X | ◯ | ◯ | X |
| | soft layer and covering layer | | | | | | | |

### Production Example 1

In accordance with the formulation shown in Table 1, the compounds for each of the soft layer and the covering layer were mixed. To each mixture, 0.5 part by mass of stearic acid, 4.0 parts by mass of magnesium oxide, 5.0 parts by mass of zinc oxide, 10 parts by mass of silica (Nipsil VN3), and other additives were further added, and the resulting mixture was kneaded with a mixing mill in accordance with JIS K 6299, giving a rubber composition of the soft layer and a blend rubber composition of the covering layer of Production Example 1.

The resulting rubber composition and the blend rubber composition were evaluated by the following procedures.

<Ozone Resistance>

The blend rubber composition of the covering layer was molded into a sheet-like sample having a width of 52 mm, a length of 45 mm, and a thickness of 2 mm, and the sample was fixed by using jigs so as to elongate the center of the sample by 20% in the length direction. The fixed sample was placed in a tester in which the ozone concentration was adjusted at 100 pphm and the temperature was adjusted at 40° C., and the time until cracks were generated on the surface of the sample was determined. A sample was evaluated as acceptable (∘) when the time exceeded 1,100 hours.

<Vulcanization Adhesiveness Between Soft Layer and Covering Layer>

Each of the rubber composition of the soft layer and the blend rubber composition of the covering layer was molded into a sheet having a width of 25 mm, a length of 150 mm, and a thickness of 2 mm. The sheets were laminated so as to leave respective end areas with a length of 50 mm as a grip for a tensile tester, and were subjected to vulcanization adhesion at 150° C. by using a vulcanizing mold. The sample after vulcanization adhesion was subjected to 180° peel test by using a tensile tester at a tensile speed of 50 mm/min. The separated faces of the sample were visually observed. A sample was evaluated as acceptable when material failure was observed (rubber pieces of one sheet adhered to the other sheet), whereas a sample was evaluated as reject when sheets were separated at the vulcanization adhesion interface. The test was performed where N=5, and if three or more samples were evaluated as acceptable, the evaluation result was indicated by ∘, whereas if not, the evaluation result was indicated by ×.

The polychloroprene, the elastomer other than the polychloroprene, the carbon black, the antioxidant, and the plasticizer shown in Table 1 were the following substances.

Polychloroprene 1: mercaptan-modified polychloroprene manufactured by Denki Kagaku Kogyo (Mooney viscosity of crude rubber: 80)

Polychloroprene 2: xanthogen-modified polychloroprene manufactured by Denki Kagaku Kogyo (Mooney viscosity of crude rubber: 70)

Polychloroprene 3: sulfur-modified polychloroprene manufactured by Denki Kagaku Kogyo (Mooney viscosity of crude rubber: 40)

Natural rubber: general purpose product with TSR20 Styrene-butadiene copolymer rubber: Nipol 1502 manufactured by Zeon Corporation

Elastomer 1: EPDM, ESPRENE 505A manufactured by Sumitomo Chemical Co., Ltd.

Elastomer 2: brominated butyl rubber, Exxon Bromobutyl 2255 manufactured by Exxon Mobil Chemical

Carbon black 1: SEAST SO (FEF carbon) manufactured by Tokai Carbon Co., Ltd.

Carbon black 2: SEAST 3 (HAF carbon) manufactured by Tokai Carbon Co., Ltd.

Antioxidant 1: Nocrac 6C manufactured by Ouchi Shinko Chemical Industrial Co., Ltd.

Antioxidant 2: Nocrac 810-NA manufactured by Ouchi Shinko Chemical Industrial Co., Ltd.

Plasticizer 1: bis(2-ethylhexyl) azelate manufactured by Daihachi Chemical Industry Co., Ltd.

Plasticizer 2: dibutyl sebacate manufactured by Daihachi Chemical Industry Co., Ltd.

Plasticizer 3: dioctyl sebacate manufactured by Daihachi Chemical Industry Co., Ltd.

Sulfur compound 1: sulfur

Sulfur compound 2: tetraethylthiuram disulfide, Nocceler TET manufactured by Ouchi Shinko Chemical Industrial Co., Ltd.

Sulfur compound 3: 4,4′-dithiodimorpholine, Vulnoc R manufactured by Ouchi Shinko Chemical Industrial Co., Ltd.

Sulfur compound 4: dip entamethylenethiuram tetrasulfide, Nocceler TRA manufactured by Ouchi Shinko Chemical Industrial Co., Ltd.

### Production Examples 2 to 25, A to F

The same procedure as in Production Example 1 was performed except that compounds were used in accordance with the corresponding formulation shown in Table 1, giving polychloroprene compositions of Production Examples 2 to 25 and A to F. The same evaluations as in Production Example 1 were performed.

The above results indicate that the rubber composition of the soft layer of each production example exerts low rigidity and large deformability in the horizontal direction, and the blend rubber composition of the covering layer of each production example has excellent ozone resistance and has excellent vulcanization adhesiveness to the polychloroprene composition used in the soft layer.

### Example 1

<Production of Rubber Bearing Sample>

The rubber composition of the soft layer of Production Example 1 was used to prepare eight rubber sheets having dimensions of 310 mm×310 mm×7.5 mm, and the rubber sheets were alternately laminated with seven rolled steel plates (SS400) having dimensions of 300 mm×300 mm×2.3 mm, giving a laminate. The blend rubber composition of the covering layer of Production Example 1 was used to prepare a rubber sheet (covering layer) having dimensions of 77 mm×1,250 mm×7.5 mm, and the rubber sheet was wound on the outer peripheral part of the laminate. The whole was vulcanized at a temperature of 155° C. for a vulcanization time of 120 min, giving a rubber bearing sample of Example 1. In the same manner, the rubber compositions of the soft layer and the blend rubber compositions of the covering layer of Production Example 12, Production Example 13, and Production Example A were used to produce rubber bearing samples of Examples 1 to 3 and Comparative Example 1.

<Evaluation of Rubber Bearing Sample>

To a sample, a bearing stress of 80 kgf/cm² was applied, and each of shear deformations of ±70%, ±150%, ±175%, and ±250% was applied three times. From the third deformation curve, the shear spring constant was calculated, and from the calculated shear spring constant, the static shear modulus was calculated. After the determination of the 250% shear spring constant, the sample was continuously shear-deformed until shear fracture, and the deformation at the shear fracture was determined.

The rubber bearing samples of Examples 1 to 3 showed the values acceptable to practical use. The rubber bearing sample of Comparative Example 1 was not acceptable to practical use.

The present invention can include the following aspects.
(1) A rubber bearing comprising a laminate prepared by alternately laminating a plurality of soft layers having rubber elasticity and a plurality of hard layers having rigidity, and a covering layer covering an outer peripheral part of the laminate. In the rubber bearing, the soft layer comprises a rubber composition containing a polychloroprene, and the covering layer comprises a blend rubber composition containing a polychloroprene in an amount of 30 to 95 parts by mass and an elastomer other than the polychloroprene in an amount of 70 to 5 parts by mass relative to 100 parts by mass of a total amount of the polychloroprene and the elastomer other than the polychloroprene.
(2) The rubber bearing according to (1), in which the soft layer comprises a rubber composition containing the polychloroprene in an amount of 50 to 95 parts by mass and an elastomer other than the polychloroprene in an amount of 50 to 5 parts by mass relative to 100 parts by mass of a total amount of the polychloroprene and the elastomer other than the polychloroprene.
(3) The rubber bearing according to (1) or (2), in which the laminate and the covering layer are bonded by vulcanization adhesion or with an adhesive.
(4) The rubber bearing according to any one of (1) to (3), in which the blend rubber composition of the covering layer contains a sulfur compound in an amount of 0.1 to 4.0 parts by mass relative to 100 parts by mass of a total amount of the polychloroprene and the elastomer other than the polychloroprene.
(5) The rubber bearing according to any one of (1) to (4), in which the elastomer other than the polychloroprene in the covering layer is at least one elastomer selected from an ethylene/α-olefin copolymer, an ethylene/α-olefin/nonconjugated polyene copolymer, and a butyl rubber.
(6) The rubber bearing according to any one of (2) to (5), in which the elastomer other than the polychloroprene in the soft layer is at least one elastomer selected from an ethylene/α-olefin copolymer, an ethylene/α-olefin/nonconjugated polyene copolymer, a butyl rubber, and a diene rubber.
(7) The rubber bearing according to any one of (1) to (6), in which the polychloroprene in the soft layer and the covering layer is at least one polychloroprene selected from a mercaptan-modified polychloroprene, a xanthogen-modified polychloroprene, and a sulfur-modified polychloroprene.

1. A rubber bearing comprising:
a laminate prepared by alternately laminating a plurality of soft layers having rubber elasticity and a plurality of hard layers having rigidity; and
a covering layer covering an outer peripheral part of the laminate,
the soft layer comprising a rubber composition containing a polychloroprene,
the covering layer comprising a blend rubber composition containing a polychloroprene in an amount of 30 to 95 parts by mass and an elastomer other than the polychloroprene in an amount of 70 to 5 parts by mass relative to 100 parts by mass of a total amount of the polychloroprene and the elastomer other than the polychloroprene.

2. The rubber bearing according to claim 1, wherein the soft layer comprises a rubber composition containing the polychloroprene in an amount of 50 to 95 parts by mass and an elastomer other than the polychloroprene in an amount of 50 to 5 parts by mass relative to 100 parts by mass of a total amount of the polychloroprene and the elastomer other than the polychloroprene.

3. The rubber bearing according to claim 1, wherein the laminate and the covering layer are bonded by vulcanization adhesion or with an adhesive.

4. The rubber bearing according to claim 1, wherein the blend rubber composition of the covering layer contains a sulfur compound in an amount of 0.1 to 4.0 parts by mass relative to 100 parts by mass of a total amount of the polychloroprene and the elastomer other than the polychloroprene.

5. The rubber bearing according to claim 1, wherein the elastomer other than the polychloroprene in the covering layer is at least one elastomer selected from an ethylene/α-olefin copolymer, an ethylene/α-olefin/nonconjugated polyene copolymer, and a butyl rubber.

6. The rubber bearing according to claim 2, wherein the elastomer other than the polychloroprene in the soft layer is at least one elastomer selected from an ethylene/α-olefin copolymer, an ethylene/α-olefin/nonconjugated polyene copolymer, a butyl rubber, and a diene rubber.

7. The rubber bearing according to claim 1, wherein the polychloroprene in the soft layer and the covering layer is at least one polychloroprene selected from a mercaptan-modified polychloroprene, a xanthogen-modified polychloroprene, and a sulfur-modified polychloroprene.
